(19) United States
(12) Patent Application Publication
(10) Pub. No.: US 2004/0019504 A1
(43) Pub. Date: Jan. 29, 2004

(54) Multi-tier forecast-based hospital staffing system

(76) Inventors: Nancy Kay Korom, Wauwatosa, WI (US); Christine Gall Fitz-Verploegh, Menasha, WI (US); Ramesh Chander Sachdeva, Mequon, WI (US)

Correspondence Address: QUARLES & BRADY LLP, 411 E. WISCONSIN AVENUE, SUITE 2040, MILWAUKEE, WI, 53202-4497, US

(21) Appl. No.: 10/438,575

(22) Filed: May 15, 2003

Related U.S. Application Data
(60) Provisional application No. 60/381,724, filed on May 17, 2002.

(51) Int. Cl. G06F 17/60

(52) U.S. Cl. 705/2

(57) ABSTRACT

A healthcare staff scheduling technique uses concurrent schedules each based on a different predictive model, where the models varying in term and accuracy. Work under each schedule is independently compensated allowing a multi-tiered approach to unexpectedly high patient census that minimizes disruption and inconvenience to healthcare staff.

### CROSS-REFERENCE TO RELATED APPLICATIONS

This application is based on provisional application No. 60/381,724 filed May 17, 2002 and entitled “Hospital Staffing Forecast System” and claims the benefit thereof.

### STATEMENT REGARDING FEDERALLY SPONSORED RESEARCH OR DEVELOPMENT

### BACKGROUND OF THE INVENTION

The present invention relates to a method and software for managing the fluctuating staffing requirements of a health care facility with changes in numbers of patients and, in particular, to a system that employs a set of forecasts of varying lengths to generate a corresponding set of schedules providing different compensation.

The number of patients treated by a hospital or other healthcare facility (the patient census) fluctuates dramatically during a year according to a complex set of underlying factors. Yet the healthcare industry, in distinct contrast to other industries, cannot simply turn away customers in the face of unexpectedly high demand. In many cases, postponing treatment or queuing sick patients is not an option.

On the other hand, staffing a healthcare facility at all times to handle worst case patient census is prohibitively expensive and undesirably increases the cost of health care.

Hospitals faced with these competing demands frequently resort to an ad hoc scheduling system where excess patient census is met by last minute changes in the schedules of staff. Such systems are burdensome to workers who, as a result of this approach, are unable to maintain predictable schedules in their personal lives. Such ad hoc systems also may increase staffing costs if unscheduled overtime becomes routine.

What is needed is a scheduling system that reduces the impositions on healthcare staff, giving workers a sense of control of their schedules, and yet which still allows the healthcare facility to meet its obligations under widely varying demand.

### BRIEF SUMMARY OF THE INVENTION

The present invention recognizes that although patient census is largely unpredictable, a set of overlapping predictions of successively shorter term and successively greater accuracy can be established. Each of these predictions can be associated with a different schedule under which work can be compensated differently. The difference in compensation can reflect, among other things, the extent to which the schedule is short-term, and thus the inconvenience to the individual following the schedule. By establishing a set of forecasts and corresponding schedules, the costs of unavoidable uncertainty in patient census is contained. The multiple schedules and compensation provide a “market” that allocates the burden of uncertainty in the patient census efficiently, in a manner that is least costly to the staff as a group.

Specifically then, the present invention provides a method of staffing a health care facility comprising the steps of establishing a series of projections of patient census having prediction terms varying between a long and short-term. A corresponding series of concurrent staffing schedules is then established, each staffing schedule providing different compensation for work by staff per the different staff schedule.

It is thus one object of the invention to capture different degrees of uncertainty about patient census into different schedules thereby minimizing the costs and disruption of such uncertainty.

The series of projections may cover a year, a two-week period and, less then a week.

Thus it is another object of the invention to provide a set of projections that fit well with the practice of healthcare. The year projection reflects generally the cyclic nature of certain diseases, the two-week projection matches the scheduling of a normal pay period, and the projection of less than a week matches a current post-hoc response to unpredicted patient census.

The compensation for a staff schedule associated with a longer-term projection may be at a lower rate than the compensation for a staff schedule associated with a shorter-term projection.

Thus it is another object of the invention to provide an incentive structure for work under a schedule that corresponds to increasing inconvenience to staff when working under shorter-term schedules.

The compensation for the staff schedule associated with the shortest-term projection may provide a lower compensation rate than the staff schedule associated with the next shortest-term projection.

Thus it is another object of the invention to prevent strategic behavior in the market for staffing such as might discourage staff from volunteering for a longer term schedule to promote the need for a shorter term schedule with higher compensation.

The projections may be based on input variables selected from the group consisting of: patient census values over an immediately preceding term, viral load during the immediately preceding term, barometric pressure during the immediately preceding term, average daily temperature range during the immediately preceding term, and minimum temperature over the immediately preceding term.

Thus it is another object of the invention to provide projections that may make use of a variety input variables to provide accurate forecasts of patient census.

At least one projection may be for no less than three months and may be produced by a time series analysis of a preceding period of no less than three years.

It is thus another object of the invention to capture seasonally cyclic patient census patterns, for example, those caused by respiratory diseases causing an increase in census in the months of January to April.

One projection may be for no more than one week and may be produced by observation of current patient census.

It is thus one object of the invention to provide certainty in having sufficient staff for any given patient census by reverting to the ad hoc staffing methods previously used in the event of failure of prediction of previous projections.

The staff schedules may include shifts subdividing a day and the proportion of the staff among the shifts may be maintained substantially constant according to patient requirements.

It is thus another object of the invention to provide a simple method of generating shift schedules by applying a factor to a pre-existing shift proportion.

These particular objects and advantages may apply to only some embodiments falling within the claims and thus do not define the scope of the invention.

### BRIEF DESCRIPTION OF THE DRAWINGS

FIG. 1 is a simplified plot of patient census superimposed with zones defining three different predictive models that produce three tiers of schedules represented next to the plot in tabular form;

FIG. 2 is a flow diagram of the development of the three schedule tiers of FIG. 1 using the predictive models; and

FIG. 3 is an example shift schedule as modified by the predictions of FIG. 2 to create daily schedules for staffing.

### DETAILED DESCRIPTION OF THE PREFERRED EMBODIMENT

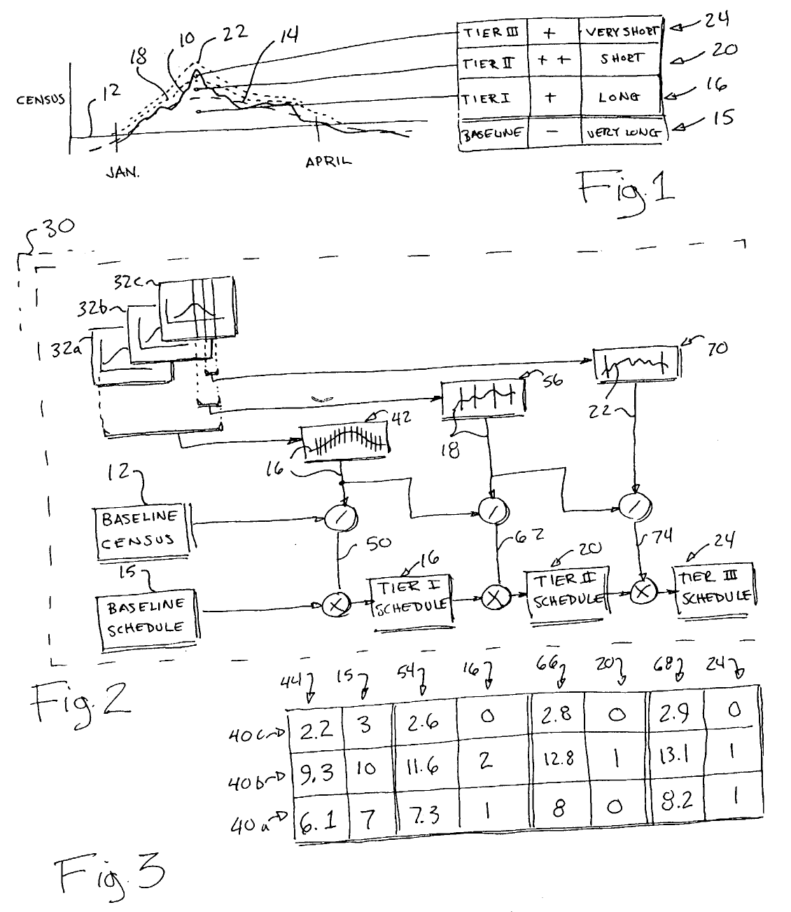

Referring now to FIG. 1, a typical patient census 10 will fluctuate during the year having a peak typically within the months from January to April. The timing of this peak, and its height is largely unpredictable, being a complex function of many variables related to the environment and population of the community.

Although perfect prediction of patient census 10 is unlikely to be achieved, patient census 10 may be modeled over the short and long term with various degrees of success. Generally the models providing a longest-term prediction are the least accurate in their prediction with shorter term modeling being more accurate.

In the present invention, a base-line census level 12, which is the average daily census for the calendar year, is first determined from the historical average requirements of the health care facility over the last several years. In some respects, this averaging is a very simple model using historical data as an input variable. The base-line census level 12 describes a number of full and part time employment work blocks for hospital staff expected to be required over the entire year taking into account holidays, expected sick leave, and other standard work exceptions. The base-line census level 12 will be satisfied by a baseline schedule 15, which is core staffing required to take care of the average daily census and required care hours of the patients, capturing a daily or weekly commitment by the staff member according to their status as full time or part time, and is substantially constant over time. As such, the baseline schedule 15 provides a very long term scheduling window as indicated by the second column of the table of FIG. 1. The baseline schedule 15 is least disruptive to staff and hours worked toward the base-line census level 12 are generally compensated at a basic compensation rate (straight time), as indicated by the dash in the second column of the table of FIG. 1.

As will be described in more detail below, the present invention uses a long-term prediction 14 to build on the base-line census level 12 and to better follow the general trend of the patient census 10 as it fluctuates during the year. The long-term prediction 14 is a more accurate prediction of patient census 10 than the base-line census level 12, and is used to develop a Tier I schedule 16. The Tier I schedule 16 provides a long term scheduling window as indicated by the second column of the table of FIG. 1 but is a departure from the baseline schedule 15, and thus slightly more disruptive to the staff than is the baseline schedule 15. For this reason, hours worked toward the Tier I schedule 16 are compensated at a higher rate (for example time and one half) than are hours under the baseline schedule 15, as indicated by the plus in the second column of the table of FIG. 1. Staff is expected to sign on for a predetermined number of hours in the Tier I schedule but are largely free to select the particular schedule work blocks on a first come, first served basis.

In the month of February, for example, when there is a high incidence of respiratory disease, the patient census 10 may exceed the long-term prediction 14. For this reason, the present invention also uses a short-term prediction 18 to build on the base-line census level 12 and the long term prediction 14 and thus to follow short term deviations from these predictions. The short-term prediction 18 is made every two weeks in the preferred embodiment, and thus provides yet a more accurate prediction of patient census 10 than the base-line census level 12 and the long-term prediction 14, and is used to develop a Tier II schedule 20. The Tier II schedule 20 provides a short term scheduling window as indicated by the second column of the table of FIG. 1 and is more disruptive to the staff than either the baseline schedule 15 or the Tier I schedule 16. For this reason, hours worked toward the Tier II schedule 20 are compensated at a higher rate (time and one half to double time) than are hours under the baseline schedule 15 or the Tier I schedule 16, as indicated by the double plus in the second column of the table of FIG. 1. In the preferred embodiment, this tier is completely voluntary. The ability to change the level of compensation helps ensure the Tier II schedule is filled.

Occasionally the short-term prediction 18 is insufficiently accurate and patient census 10 may rise above the short-term prediction 18. In effect, the present invention therefore also provides a very-short-term prediction 22 being essentially an ad hoc evaluation of staffing, similar to that done on a routine basis in other health care staffing systems, looking out only to the next shift or a day or two in advance. Because of the extremely short prediction span of this very-short-term prediction 22, it is essentially impossible for the patient census 10 to exceed this very-short-term prediction 22 so long as there are staff available. The Tier III schedule 24, produced as a result of the very-short-term prediction 22, is unfortunately highly disruptive to the personal lives of the staff requiring very short notice changes in schedules, and a principle goal of the multiple prediction levels of the present invention is to therefore minimize the necessary scheduling under Tier III schedule 24. This is done to the extent possible principally by improving the models used for the earlier prediction.

Compensation for work under the Tier III schedule 24, as indicated by the second column of the table of FIG. 1, is less than compensation for working under the Tier II schedule 20 but may be comparable to the compensation working under the Tier I schedule 16 and is typically greater than the compensation at the base-line census level 12. The reason for this compensation approach is to provide additional incentive for staff to volunteer for the Tier II schedule allowing it to be voluntary, and thus least disruptive to the staff as a whole, while preventing any incentive to encourage Tier III schedule hours. In the preferred embodiment, work under a Tier III schedule may be compensated at time and one half and there may be non pecuniary rewards, for example, gift coupons provided to those who work under this schedule. Work under the Tier III schedule may be mandatory if necessary.

Generally the compensation described above reflects compensation for employees for not working overtime. When overtime work is required, compensation according to the Fair Labor Standards Act is provided.

Thus the uncertainty of the actual patient census 10 is divided into a variety of different schedules (Tier I schedule 16, Tier II schedule 20, and Tier III schedule 24) according to the term and accuracy of the corresponding long-term prediction 14, short-term prediction 18, and very-short-term prediction 22. Note that all three schedules of Tier I through Tier III are simultaneously operating, and thus it is possible for two employees working at the same time to be compensated in different amounts depending on which schedule their work is under.

Referring now to FIG. 2, the generation of the long-term prediction 14, short-term prediction 18, and very-short-term prediction 22 and the Tier I schedule 16, Tier II schedule 20, and Tier III schedule 24 may be performed in part or entirely by a program 30 executing on a personal computer or the like (not shown) having an architecture well known to those of ordinary skill in the art.

Program 30 receives historical census data 32a, 32b, and 32c collected for the particular health care facility over a number of years, where census data 32c is the current census data for the given year immediately preceding the date on which the program 30 is being used. The program 30 may calculate a base-line census level 12 being the normal employment levels at the hospital or this may be provided as indicated from normal employment records.

Referring now also to FIG. 3, the program also receives a baseline schedule 15 which, in this example, provides for three shifts 40a, 40b, and 40c (e.g., morning, afternoon, and evening shifts). For each shift 40, the baseline schedule 15 records raw baseline work blocks 44 required on average during the year. A work block represents the smallest practical unit of scheduled work, for example, four hours of work by one person. Note that these raw baseline work blocks 44 may be fractional and are normally rounded up to produce the baseline schedule 15 indicating generally the number of staff required for a given shift 40.

In the example shown, it will be assumed that the work block is an eight hour shift and thus seven staff members required in the morning shift 40a, ten in the afternoon shift 40b, and three in the night shift 40c based on raw baseline work blocks 44 values of 6.1, 9.3 and 2.2, respectively.

Referring again to FIG. 2 on a yearly basis, a long-term modeling algorithm 42 receives the historical data typically for a number of years, e.g., census data 32a, 32b, and 32c, to produce a long-term prediction 14 of patient census. This long-term modeling algorithm 42 may, for example, take an averaging on a weekly basis of patient census 10 over the last three years or may be a more sophisticated time series analysis well known to those of ordinary skill in the art. It will be understood that other modeling techniques well known in the art may be used for the long-term modeling algorithm 42.

The long-term prediction 14 is read for each pay period, typically being two weeks, and compared to the base-line census level 12 to produce a long-term error factor 50. For example, the long-term prediction 14 for the given pay period may indicate a predicted twenty percent increase in patient census 10 over the baseline census level 12.

This long-term error factor 50 is multiplied by the raw baseline work blocks 44 of the baseline schedule 15 to produce the Tier I schedule 16 shown in FIG. 3. In the example of FIG. 3, the raw baseline work blocks 44 of the baseline have been multiplied by twenty percent to produce raw Tier I work blocks 54 which have been rounded upward to produce the Tier I schedule 16 reflecting an additional two work blocks in the afternoon shift and one additional work block in the morning shift.

This Tier I schedule 16 supplements the baseline schedule 15 and allows staff to nominate themselves to fill on a first come, first served basis the additional work blocks to meet a mandatory participation number.

Referring again to FIG. 2, on a bi-weekly basis, a short-term modeling algorithm 56 reviewing the previous pay period of the most recent census data 32 generates the short-term prediction 18 that may be compared to the long-term prediction 14 to produce a short-term error factor 62.

The short-term modeling algorithm 56 typically will take as input variables: the patient census 32a on a previous day or averaged over a previous period, viral load on a previous day or averaged over a previous period, barometric pressure on a previous day or averaged over a previous period, and minimum temperature or temperature range as incorporates minimum temperature, on a previous day or averaged over a previous period. The previous day may be five to seven days earlier reflecting the fact that many viral diseases have a five to seven day incubation period. Viral load may be, for example, the number of total viruses recorded in hospitals in the area or the number of different viruses such as may be obtained from a variety of health services. For example, viral loads in southeastern Wisconsin may be obtained from “http://www.prodesse.com”, but are also available from organizations such as the Center for Disease Control and state organizations.

These and other desirable input variables for predicting patient census may be developed by analyzing historical data and performing a regression analysis with respect to the given input variable. The regression analysis both identifies useful input variables but establishes coefficients of the form ax₀+bx₁+cx₂ . . . to effect the modeling where x₀ through x₂ are the input variables and a through c are coefficients establishing the functional dependence between the input variable and patient census 10. As part of the invention, the particular input variables and their regression coefficients may be recomputed on a periodic basis to improve the accuracy of the short-term modeling algorithm 56. It will be understood that other input variables and other modeling techniques well known in the art may be used for the short-term modeling algorithm 56.

In the example of FIG. 3, the short-term error factor 62 indicates an additional 1% of patient census will be expected over the base-line census level 12 and long-term prediction 14 producing raw Tier II work blocks 66 which are rounded up to produce Tier II schedule 20. Staff may voluntarily elect to fill these work blocks on a first come, first served basis.

Referring again to FIG. 2, a very-short-term prediction 22 can be produced by very-short-term modeling algorithm 70. The very-short-term modeling algorithm 70 is essentially a review of the staffing shortfall of the moment or the previous day or the previous several days. This very-short-term prediction 22 is compared to the short-term prediction 18 to provide a very-short-term error factor 74 that may be used by multiplying very-short-term error factor 74 by the Tier II schedule 20. Tier III scheduling is the least desirable scheduling because it provides no advance warning to staff that they may be needed, however, it necessarily provides necessary staffing in the event of unexpected census. Nevertheless, to the extent that long-term modeling algorithm 42 and short-term modeling algorithm 56 are accurate, the Tier III schedule 24 will not be required. Staff are recruited to fill these work blocks on a mandatory basis.

In the example shown in FIG. 3, a very-short-term error factor 74 of 0.2% increase in patient census beyond that predicted by short-term modeling algorithm 56 produces raw Tier III work blocks 68 which are rounded up to produce Tier III schedule 24 causing an increase in one person for the morning and afternoon shifts 40a and 40b.

It should be noted that each of the long term modeling algorithms 42, short-term modeling algorithm 56, and very-short-term modeling algorithm 70 employs as an input recent census data, and thus the models are largely self-correcting, quickly compensating any modeling errors within one period of the model.

It is specifically intended that the present invention not be limited to the embodiments and illustrations contained herein, but include modified forms of those embodiments including portions of the embodiments and combinations of elements of different embodiments as come within the scope of the following claims.

We claim:

1. A method of staffing a health care facility comprising the steps of:
(a) establishing a series of projections of patient census having prediction terms varying between long to short-term;
(b) establishing a series of concurrent staffing schedules corresponding to the series of projections, the staff schedules defining scheduling of staff for future time periods corresponding in length substantially to the varying prediction term of the associated projections; and
(c) providing for each different staff schedule a different compensation for work by staff per that schedule;
whereby staffing of the health care facility is substantially equal to the sum of the staffing defined by each staff schedule.

2. The method of claim 1 wherein the series of projections cover a year, a two week period, and less than a week.

3. The method of claim 1 wherein the compensation for a staff schedule associated with a first projection provides lower compensation than a staff schedule associated with a second longer term projection.

4. The method of claim 1 wherein the compensation for a staff schedule associated with the shortest term projection provides a lower compensation rate than a staff schedule associated with the next shortest term projection.

5. The method of claim 1 wherein the projections model patient census over their terms using input variables selected from the group consisting of: patient census values over an immediately preceding term, viral load during the immediately preceding term, barometric pressure during the immediately preceding term, average daily temperature range during the immediately preceding term, minimum temperature over the immediately preceding term.

6. The method of claim 1 wherein at least one projection is for no less than three months and is produced by a time series analyses of a preceding period of no less than three years.

7. The method of claim 1 wherein at least one projection is for no more than three weeks and is produced by regression analyses of a preceding period using a set of input variables selected from the group consisting of historical data of an immediately preceding term, viral load during the immediately preceding term, barometric pressure during the immediately preceding term, average daily temperature range during the immediately preceding term, and minimum temperature over the immediately preceding term.

8. The method of claim 1 wherein at least one projection is for no more than one week and is produced by observation of the current patient census.

9. The method of claim 1 wherein the staffing schedule includes shifts subdividing a day and wherein the relative proportion of staffing among the shifts is maintained substantially constant.

10. A computer program to aid in staffing a health care facility, the program executing on a computer to:
(i) receive historical census data;
(ii) apply the census data to a mathematical model to produce a series of projections of patient census having predication terms varying between long to short-term; and
(iii) generate a series of concurrent staffing schedules corresponding to the series of projections, the time periods of the staff schedules corresponding substantially to the prediction terms of the associated projections, each staff schedule providing different compensation for work by staff;
whereby staffing of the health care facility is substantially equal to the sum of the staffing defined by each staff schedule.

11. The computer program of claim 10 wherein the series of projections cover a year, two weeks, and less than a week.

12. The computer program of claim 10 wherein the compensation for the staff schedule associated with a first term projection provides lower compensation than the staff schedule associated with the second longer term projection.

13. The computer program of claim 10 wherein the compensation for the staff schedule associated with a shortest term projection provides lower compensation than a staff schedule associated with the next shortest term projection.

14. The computer program of claim 10 wherein the computer program further receives input variables selected from the group consisting of: patient census values over an immediately preceding term, viral load during the immediately preceding term, barometric pressure during the immediately preceding term, average daily temperature range during the immediately preceding term, minimum temperature over the immediately preceding term.

15. The computer program of claim 10 wherein at least one projection is for no less than three months and is produced by a time series analyses of a preceding period of no less than three years.

16. The computer program of claim 10 wherein at least one projection is for no more than three weeks and is produced by a regression analyses of a preceding period using a set of input variables selected from the group consisting of: historical data of an immediately preceding term, viral load during the immediately preceding term, barometric pressure, average daily temperature range during the immediately preceding term, and minimum temperature over the immediately preceding term.

17. The computer program of claim 10 wherein at least one projection is for no more than one week and is produced by observation of the current patient census.
